(19) United States
(12) Patent Application Publication
(10) Pub. No.: US 2012/0174581 A1
(43) Pub. Date: Jul. 12, 2012

(54) Closed-Loop Systems and Methods for Geothermal Electricity Generation

(76) Inventors: Susanne F. Vaughan, Austin, TX (US); Mary Robin Dahlheim, Lakeway, TX (US)

(21) Appl. No.: 12/986,047

(22) Filed: Jan. 6, 2011

(51) Int. Cl. F03G 7/00; H01L 37/04; H02P 9/04; H01S 4/00

(52) U.S. Cl. 60/641.2; 29/592.1; 310/306; 290/40 C

(57) ABSTRACT

A system includes at least one pipe system defining a closed-loop fluid conduit configured to circulate a fluid into a cased well and through at least a portion of a subterranean thermal reservoir to heat the fluid. The system further includes a thermal power system coupled to the at least one pipe system and configured to generate electricity from heat carried by the fluid.

### FIELD

The present disclosure is generally related to systems and methods of generating electricity using geothermal energy, and more particularly to closed-loop systems and methods for geothermal electricity generation.

### BACKGROUND

Conventionally, low-temperature geothermal power plants utilize geo-pressured formations to produce hot water at the surface to run Organic Rankine Cycle (ORC) systems. ORC systems use an organic, high molecular mass fluid with a liquid-vapor phase change, or boiling point, occurring at a lower temperature than the water-steam phase change (i.e., at temperatures that are at or below 212 degrees Fahrenheit). Typically, such plants retrieve heated fluid from a geo-pressured formation or other lower temperature sources, such as industrial waste heat, geothermal heat, solar ponds, etc., and convert the heat into useful work, which can be converted into electricity.

However, retrieval of such heated fluid for use in an ORC system produces significant waste fluid, which must be disposed of safely. For example, fluid recovered from a geothermal formation often includes salt and other minerals that should not be discharged into the atmosphere or allowed to flow into the water table. Typically, such fluids are extracted from the geothermal formation and are then re-injected into another formation, which may be below the water table.

Some low-temperature geothermal power plants also produce some oil and gas, which must be separated. While the production of oil or gas may be considered a beneficial side effect, there are two main problems with this type of system. First, the re-injected water, which may be highly saline or contain hydrogen sulfides, may find its way into aquifers used for water wells or for agricultural irrigation. Second, the geo-pressured formation may be depleted over time, similar to the way in which oil and gas wells become depleted, decreasing production of heated fluid and reducing the ability to generate electricity from the formation fluid. Moreover, hot, saline water withdrawn from geo-pressured formations often contain toxic gases or chemicals, which can be released into the atmosphere by the processor of bringing them to the surface if the fluid is not handled properly.

### SUMMARY

In an embodiment, a system includes at least one pipe system defining a closed-loop fluid conduit configured to circulate a fluid into a cased well and through at least a portion of a subterranean thermal reservoir to heat the fluid. The system further includes a thermal power system coupled to the at least one pipe system and configured to generate electricity from heat carried by the fluid.

In another embodiment, a method includes circulating a fluid through a closed-loop pipe system having a portion that extends into a cased well and through a subterranean thermal reservoir to heat the fluid. The method further includes circulating the fluid through a second portion of the closed-loop pipe system that extends through a thermal-electric generator to convert heat carried by the fluid into electricity and supplying the electricity to a destination.

In yet another embodiment, a system includes a pipe system configured to provide a closed-loop fluid conduit for carrying a fluid from a surface through a first well bore associated with a cased well and through at least a portion of a subterranean thermal reservoir and back to the surface through a second well bore associated with a second well. The system further includes an electrical generator coupled to the pipe system and configured to generate electricity from heat carried by the fluid and a control system coupled to the electrical generator to control delivery of the electricity to a destination.

In still another embodiment, a method of forming a geothermal electricity generation system includes drilling a first substantially lateral hole from a bottom of a first cased well toward a second cased well through a subterranean thermal reservoir to a pre-determined percentage of a distance between the first cased well and the second cased well. The method further includes extending a coiled tube (or other piping or casing) having a magnetic tip through the first cased well and to the pre-determined percentage of the distance within the first substantially lateral hole, and drilling a second substantially lateral hole from a bottom of the second cased well toward the magnetic tip of the coiled tube (or other piping or casing) through a subterranean thermal reservoir until the second substantially lateral hole intersects the first substantially lateral hole. Further, the method includes pulling the coiled tube (or other piping or casing) through the second substantially lateral hole and through the second cased well and coupling the coiled tube (or other piping or casing) to a pipe system, the pipe system for coupling the first cased well and the second cased well to form a closed-loop fluid conduit including the coiled tubing (or other piping or casing).

### BRIEF DESCRIPTION OF THE DRAWINGS

FIG. 1 is partial block diagram and partial cross-sectional diagram of an embodiment of a system having a closed-loop fluid conduit and configured to generate electricity from heat.

FIG. 2 is a block diagram of an embodiment of a portion of the system of FIG. 1.

FIG. 3 is a block diagram of a first embodiment of a portion of a closed-loop fluid conduit of FIG. 1 that includes multiple lateral portions extending through a subterranean thermal reservoir from a first well to a second well.

FIG. 4 is a block diagram of a second embodiment of a portion of a closed-loop fluid conduit of FIG. 1 that includes multiple lateral portions extending through a subterranean thermal reservoir from a first well to multiple wells.

FIG. 5 is a flow diagram of an embodiment of a method of assembling the closed-loop fluid conduit of FIG. 1.

FIG. 6 is a flow diagram of an embodiment of a method of controlling fluid flow through the closed-loop fluid conduit to heat a fluid and to produce electricity using the systems of FIGS. 1 and 2.

FIG. 7 is a flow diagram of an embodiment of a method of metering the supply of electricity from the systems of FIGS. 1 and 2.

In the following description, the use of the same reference numerals in different drawings indicates similar or identical items.

### DETAILED DESCRIPTION OF ILLUSTRATIVE EMBODIMENTS

Texas has over 600,000 wells that have been drilled. Most are abandoned. Louisiana, New Mexico, Mississippi, Arkansas, and Oklahoma also have many abandoned wells. Some of these wells terminate in formations that meet the temperature requirements for use in a low temperature geothermal power system such as an Organic Rankine Cycle (ORC) system. It is not unusual to find wells with bottom-hole temperatures (BHTs) from 225 degrees to 400 degrees, especially in the Frio and Wilcox formations along the Gulf coast.

Embodiments of systems and methods described below are configured to take advantage of the high bottom-hole temperatures to heat fluid within a closed-loop fluid conduit. By circulating fluid within a closed-loop fluid conduit that extends through the fluid reservoir, the high bottom-hole temperatures heat the circulating fluid without extracting the hot formation fluids, allowing the geothermal system to produce electricity from the heat carried by the circulating fluid without concern for depletion of the thermal reservoir.

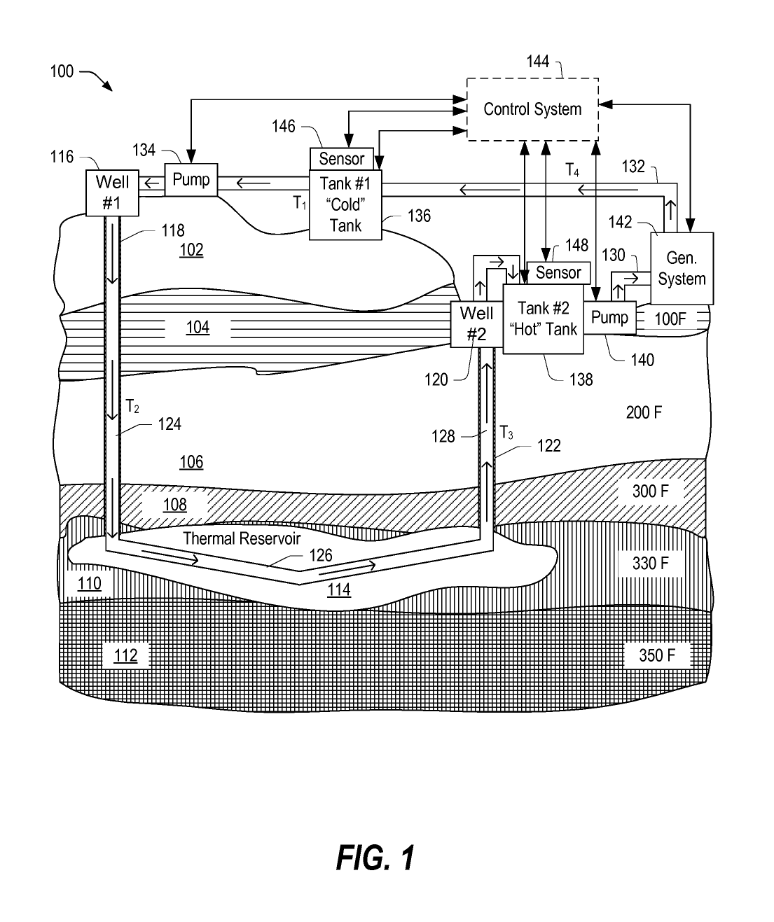

FIG. 1 is partial block diagram and partial cross-sectional diagram of an embodiment of a system 100 having a closed-loop fluid conduit and a generator configured to generate electricity from heat. System 100 makes use of a geophysical formation from which oil or gas (or both) was previously extracted. The geophysical formation may include any number of layers, including a first layer 102, a second layer 104, a third layer 106, a fourth layer 108, a fifth layer 110, and a sixth layer 112. The temperature of the layers increases as the depth increases. For example, in the illustrated embodiment, first layer 102 has a temperature that gradually increases from approximately an ambient air temperature to approximately 100 degrees Fahrenheit. Layer 104 has a temperature of approximately 100 degrees Fahrenheit. Layer 106 has a temperature of approximately 200 degrees Fahrenheit. Layer 108 has a temperature of approximately 300 degrees Fahrenheit. Layer 110 has a temperature of approximately 330 degrees Fahrenheit. Layer 112 has a temperature of approximately 350 degrees Fahrenheit. The geophysical formation further includes a subterranean thermal reservoir 114, which may be filled with formation fluid at approximately the temperature of the surrounding layer 110.

System 100 includes a first well 116 having a first well bore 118 extending from a surface of the geophysical formation to the subterranean thermal reservoir 114. System 100 further includes a second well 120 having a second well bore 122 extending from the surface to the subterranean thermal reservoir. In a particular embodiment, first well 116 and second well 120 are cased wells. A cased well is a well having a well bore that has a surface casing for at least a portion of the well bore. The surface casing provides support during drilling operations and prevents collapse of the loose soil near the surface. Intermediate casing is used for deep wells to lend structural support to the bore to prevent blowouts that may cause a hydrostatic pressure that can fracture deeper formations. Casing placement is selected so that the hydrostatic pressure of the drilling fluid remains at a pressure level that is between formation pore pressures and fracture pressures. Casing may also include production casing, which can extend to the surface. In some instances, a liner may be used which extends just above the shoe (bottom) of the previous casing interval and which is “hung off” down-hole rather than at the surface.

Few wells actually produce through casing, since producing fluids can corrode steel or form deposits such as asphaltenes or paraffins, and the relatively large casing diameter can make flow unstable. Production tubing is therefore installed inside the last casing string and the tubing annulus is usually sealed at the bottom of the tubing by a packer.

First well 116 and second well 120 can be, for example, previously abandoned oil or gas wells. In an example, first well 116 and second well 120 were re-permitted and opened by uncapping the wells and drilling through the cement plugs at the bottom. Further, the wells are drilled substantially horizontally (laterally) toward one another. First well 116 may be several hundred feet to thousands of feet away from second well 120.

In an example, first well 116 is drilled first, through a first well bore 118, and a portion of a lateral well bore is drilled through subterranean thermal reservoir 114. When at least half of the distance between the wells has been drilled through the first well, the drill string is removed and a fluid conduit (such as a coiled tube or one or more pipes) is inserted to the drill depth. A magnetic tip or spearhead may be attached to the end of the fluid conduit. Then, the second well 120 is drilled through a second well bore 122 and a portion of a lateral well bore is drilled through subterranean thermal reservoir 114 toward the first well, using magnetic ranging to intersect the first lateral well bore. The drill string is removed, and retrieval equipment is used to capture the fluid conduit and to pull it through the lateral well bore and up the second well bore 122 through the second well 120 to complete a subterranean portion of a closed-loop pipe system.

As used herein, the term “fluid conduit” refers to any type of fluid-carrying structure suitable for circulation of heated fluid below and/or above ground. One possible example of a fluid-conduit is coiled tubing. Relative to the casing, for example, coiled tubing is easier to remove for maintenance, replacement, or for various types of operations. Further, coiled tubing is significantly lighter than the casing and does not require a drilling rig to run in and out of hole. Instead, smaller “pulling units” can be used to install coiled tubing. Depending on the particular installation, coiled tubing, pipe sections, casing sections, other types of fluid-carrying structures, or any combination thereof may be used to form the fluid conduit. As used herein, the term “closed-loop pipe system”, “closed-loop conduit” or “closed loop fluid conduit” refers to the fluid conduit configured so as to circulate fluid without exchanging or discharging the fluid outside of the system. Thus, a closed-loop conduit can circulate fluid through first well 116, subterranean thermal reservoir 114, second well 120, first tank 146, second tank 138 and other pipe or tube sections without discharging the fluid either above or below ground. By maintaining the closed-loop circulation, the fluid may be heated without environmental contamination.

The closed-loop pipe system includes a first portion 124 extending from the surface into at least a portion of the subterranean thermal reservoir 114, a second portion 126 extending substantially laterally through the subterranean thermal reservoir 114, a third portion 128 extending from the subterranean thermal reservoir 114 to the surface through second well bore 122, a fourth portion 130 extending through an electrical generator system 142, and a fifth portion 132 extending between electrical generator system 142 and a first tank 136, which is connected to the first portion 124.

System 100 includes a pump 134 for pumping fluid from first tank 136 into first portion 124 of the closed-loop pipe system and through second portion 126 and third portion 128 into a second tank 138, which is near second well 120. System 100 further includes a pump 140 configured to pump the fluid from second tank 138 through fourth portion 130, through electrical generator system 142, and through fifth portion 132 into first tank 136.

System 100 includes a control system 144 connected to pump 134 and pump 140 to control fluid flow through the closed-loop pipe system. Further, system 100 includes a first sensor 146 connected to first tank 136 and to control system 144. System 100 also includes a second sensor 148 connected to second tank 138 and to control system 144. System 100 can include any number of sensors, including fluid flow meter devices, temperature sensors, pressure sensors, level measurement gauges, corrosion monitoring devices, and the like. In an embodiment, first sensor 146 and second sensor 148 include multiple sensors including at least one temperature sensor for measuring a temperature of a fluid within first tank 136 and second tank 138, respectively.

In operation, control system 144 controls pump 146 to pump fluid from first tank 136 through the closed-loop piping system into second tank 138. The fluid within first tank 136 has a first temperature (T₁). As the fluid flows through the first portion 124 of the closed-loop pipe system, the fluid temperature increases (as indicated by a second temperature (T₂)) as the layer temperatures increase. As the fluid flows through the subterranean thermal reservoir through second portion 126, the fluid temperature continues to increase to third temperature (T₃), and the heated fluid traverses the third portion 128 and flows into second tank 138. The heat carried by the fluid depends a large number of parameters, including the boiling point of the fluid within the second portion 126 of the fluid conduit, the temperatures of the layers, the temperature of the formation fluid, heat transfer characteristics of the fluid conduit and the formation fluid, the diameter of the fluid conduit, and the fluid flow rate.

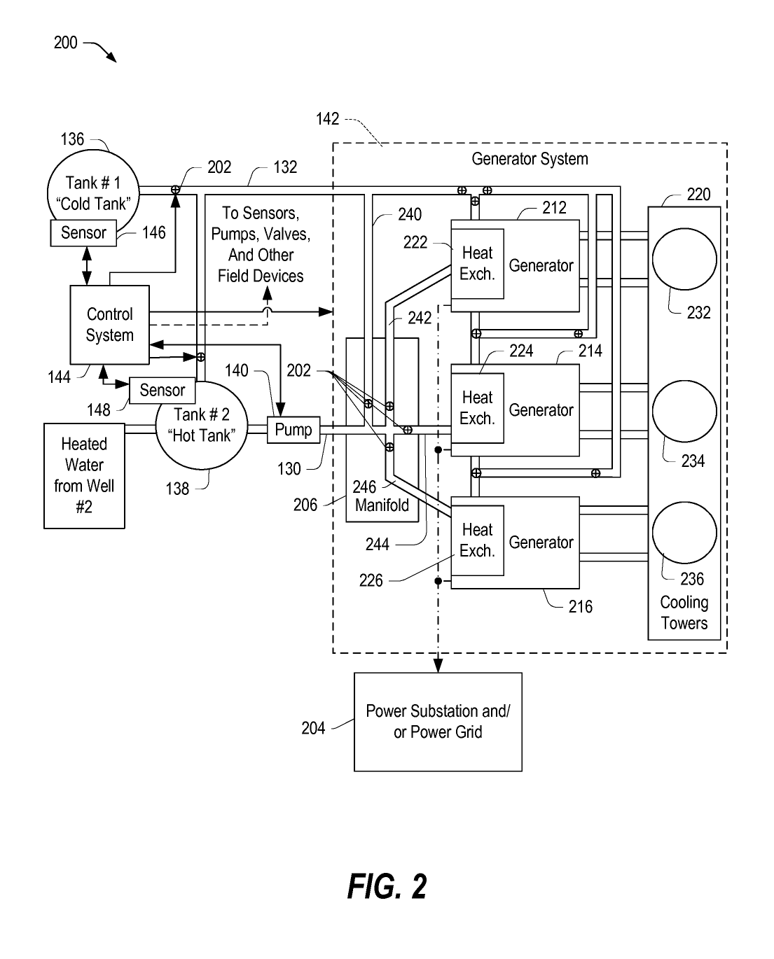

Control system 144 monitors the temperature of the fluid within second tank 138. If the fluid temperature is below a temperature threshold, control system 144 can control one or more valves (shown in FIG. 2) and pump 140 to circulate the fluid back to first tank 138 through fifth portion 132, bypassing electrical generator system 142, so that the fluid can be re-circulated through subterranean thermal reservoir 114 to further heat the fluid. Thus, control system 144 controls circulation of the fluid until the fluid temperature in second tank 138 reaches a threshold temperature level. In an embodiment, the threshold temperature level can be a stable temperature, which temperature will be reached by circulating the fluid through the closed-piping system and detecting no change in fluid temperature in second tank 138 for a pre-determined period of time. When the temperature in second tank 138 remains substantially constant over the pre-determined period, control system 144 determines that the operating temperature is reached.

Once the fluid temperature reaches or exceeds the threshold temperature level or the operating temperature is reached, control system 144 controls the one or more valves to circulate the fluid through electrical generator system 142. In an embodiment, the threshold temperature at which electrical generator system 142 produces electricity determines the threshold temperature level. Electrical generator system 142 converts the heat carried by the fluid into electricity, which can be supplied to a destination, such as a power station or the power grid. Control system 144 selectively controls the supply and meters the supplied electricity per unit of energy, so that an entity associated with the destination can be billed appropriately.

FIG. 2 is a block diagram of an embodiment of a portion 200 of the system 100 of FIG. 1. Portion 200 includes above-ground or near surface portions of the system 100, including first tank 136, second tank 138, sensors 146 and 148, pump 140, control system 144, fourth pipe portion 130, fifth pipe portion 132, and one or more electrical generators 142. Electrical generators 142 are connected to a destination 204, which may be a power substation and/or a power grid.

Control system 140 controls pump 140 to drive heated fluid from second tank 138 through fourth portion 130 of the closed-loop fluid conduit (pipe system). Control system 144 controls valves 202, which are distributed throughout the closed-loop pipe system, to control fluid flow through various fluid flow paths, including a bypass fluid flow path 240, a first fluid flow path 242 to generator 212, a second fluid flow path 244 to generator 214, and a third fluid flow path 246 to generator 216. For example, when control system 144 detects a fluid temperature at second tank 138 using sensor 148 that is below a threshold temperature, control system 144 opens a valve to direct fluid flow through bypass fluid flow path 240 and closes valves to stop fluid flow through first fluid flow path 242, second fluid flow path 244, and third fluid flow path 246. Further, control system 144 controls a valve 202 to permit fluid to flow from bypass fluid flow path 240 to first tank 136 for recirculation through subterranean thermal reservoir 114.

Electrical generator system 142 includes a manifold 206 including an inlet connected to pump 140 through fourth pipe portion 130 and outlets connected to bypass fluid flow path 240, first fluid flow path 242, second fluid flow path 244, and third fluid flow path 246. Bypass fluid flow path 240 connects manifold 206 to fifth pipe portion 132, which flows into first tank 136. First fluid flow path 242 connects manifold 206 to a heat exchange 222 within generator 212. Second fluid flow path 244 connects manifold 206 to heat exchanger 224 within generator 214. Third fluid flow path 246 connects manifold 206 to heat exchanger 226 within generator 216. Heat exchangers 222, 224, and 226 convert heat into useful work, which can be converted into electricity.

Electrical generator system 142 further includes a cooling system 220 including a first cooling tower 232, a second cooling tower 234, and a third cooling tower 236. Generator 212 is connected to first cooling tower 232. Generator 214 is connected to second cooling tower 234. Generator 216 is connected to third cooling tower. Cooling for generators 212, 214 and 216 may be provided, as shown, with cooling towers containing cool water. Alternatively, generators 212, 214, and 216 may be air cooled (using fans and radiators) or may be cooled using earth-cooling loops extending through upper layers of the rock formation. Generators 212, 214, and 216 may be individually “skid-mounted” so that they can be disconnected and removed with a machine, such as a forklift and replaced in a modular fashion with a backup (replacement) unit, reducing downtime.

In an example, generators 212, 214 and 216 are low-temperature, ORC systems configured to generate electricity from heat at temperatures at or below a boiling temperature of water. However, other types of generators may also be used, depending on the temperature of the fluid flowing within closed-loop pipe system. In a particular embodiment, each time the fluid is circulated through one of the generators 212, 214, or 216, the temperature of the fluid decreases by approximately 25 degrees Fahrenheit. In one instance, control system 144 may control valves 202 to circulate the fluid through electrical generator system 142 more than one time before allowing the fluid to flow back into first tank 136 for re-circulation through subterranean thermal reservoir 114.

In an embodiment, the fluid circulating through closed-loop pipe system can be water, salt-water, or a fluid composition. In a particular example, the fluid is a fluid composition having a boiling point at a temperature that is greater than the boiling temperature of water. Further, since the fluid is maintained within a closed loop, the fluid may include anti-corrosive chemicals that may be toxic to the environment if released but that operate to prevent or reduce corrosion of the closed-loop pipe system, thereby extending the useful life of the fluid conduit.

Generator 212, generator 214, and generator 216 generate electricity in response to receiving the heated fluid through fluid flow paths 242, 244, and 246, and provide the electricity to an output, which may be controllably connected to destination 204. A switch or other controllable elements (not shown) may be provided between generators 212, 214, and 216 and destination 204. In a particular embodiment, each generator 212, 214, and 216 is configured to generate at least 0.5 kilowatts of power per hour.

In operation, pump 140 pushes hot water from second tank 138 to heat exchangers 222, 224, and 226 for generators 212, 214, and 216, respectively. The water may flow in series through each generator or through separate flow paths. The return water may be returned to second tank 138 through fluid flow return path 248. Hotter water from the top of second tank 138 is pumped into generator system 142, and cooler water from the bottom of second tank 138 is pumped through fluid flow path 132 to first tank 136 for reheating. In one instance, pump 140 may include one or more pumps to pump fluid through the multiple fluid flow paths.

In an alternative embodiment, water heated by passing through the subterranean thermal reservoir 114 is pumped directly through heat exchangers 122, 124, and 126 and returned to first tank 136 for reheating. In this alternative embodiment, second tank 138 may be omitted. In another alternative embodiment, after the fluid passes through heat exchangers 122, 124, and 126, control system 144 selectively directs the fluid either into first tank 136 or circulates the fluid through electrical generator system 142 again.

In an example, any number of fluid conduits (or tubes) may be fed through the first well bore 118, the second well bore 122, and the substantially horizontal well bore to form multiple closed-loops through subterranean thermal reservoir 114. Multiple lateral bore holes from one well to another are possible if the casing of the well bore at the bottom of the particular well has a diameter large enough to accommodate more than one set of coiled tubing and a drill bit. In particular, after drilling, removal of the drill string, and insertion of the fluid conduit, the casing at the bottom of the well bore has to have sufficient room for the fluid conduit and the drill bit in order to drill one or more additional lateral holes.

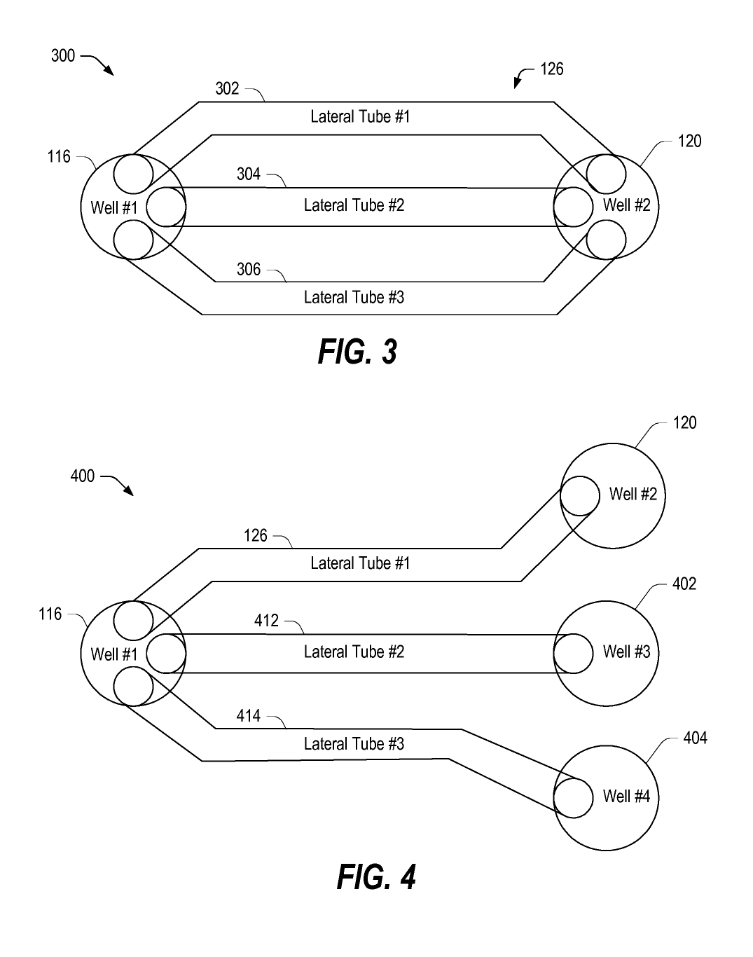

In a system having multiple lateral holes, after a first lateral hole is connected, another lateral bore hole can be started at an angle relative to the first lateral bore. In an example, the angle can be approximately ninety degrees relative to the first lateral hole. Once the lateral hole is started, the lateral drill hole can be curved back toward the second well 120. One example of a closed-loop fluid conduit including multiple lateral bore holes is described below with respect to FIG. 3.

FIG. 3 is a block diagram of a first embodiment of a portion 300 of the closed-loop pipe system, corresponding to second portion 126 of system 100 of FIG. 1, including multiple lateral portions 302, 304, and 306 extending through a subterranean thermal reservoir 114 from a first well 116 to a second well 120. In this instance, both first well 116 and second well 120 had casings with a diameter at the bottom that was large enough to accommodate three sets of coiled tubing and/or two sets of coiled tubing and a drill bit.

In the illustrated embodiment, lateral conduit 302 and lateral conduit 306 initially extend from first well 116 and from second well 120 at angles of approximately forty-five degrees relative to lateral conduit 304. After a brief distance to create separation between the lateral holes, the drill may be redirected toward the second well.

While the illustrated example depicts an angle of approximately forty-five degrees relative to lateral conduit 304 and a second angle of approximately forty-five degrees to redirect lateral conduits 302 and 306 toward the second well 320, other angles are also possible. Further, rather than redirecting lateral conduits 302 and 306 using sharp turns or angles, lateral conduits 302 and 306 can gradually curve toward a corresponding angled portion of the other well. In a particular embodiment, lateral conduits 302 and 306 may start off at an initial angle of approximately ninety degrees relative to lateral conduit 304, and lateral conduits 302 and 306 gradually curve toward a corresponding angled portion at the other well.

FIG. 4 is a block diagram of a second embodiment of a portion 400 of a closed-loop pipe system, including second portion 126 of system 100 of FIG. 1 and including lateral portions 412 and 414 extending through a subterranean thermal reservoir from a first well 116 to multiple wells. Lateral portion 412 extends from first well 116 to third well 402, and lateral portion 414 extends from first well to fourth well 404. In this example, second well 120, third well 402, and fourth well 404 can each have an associated a hot water fluid tank, such as fluid tank 138.

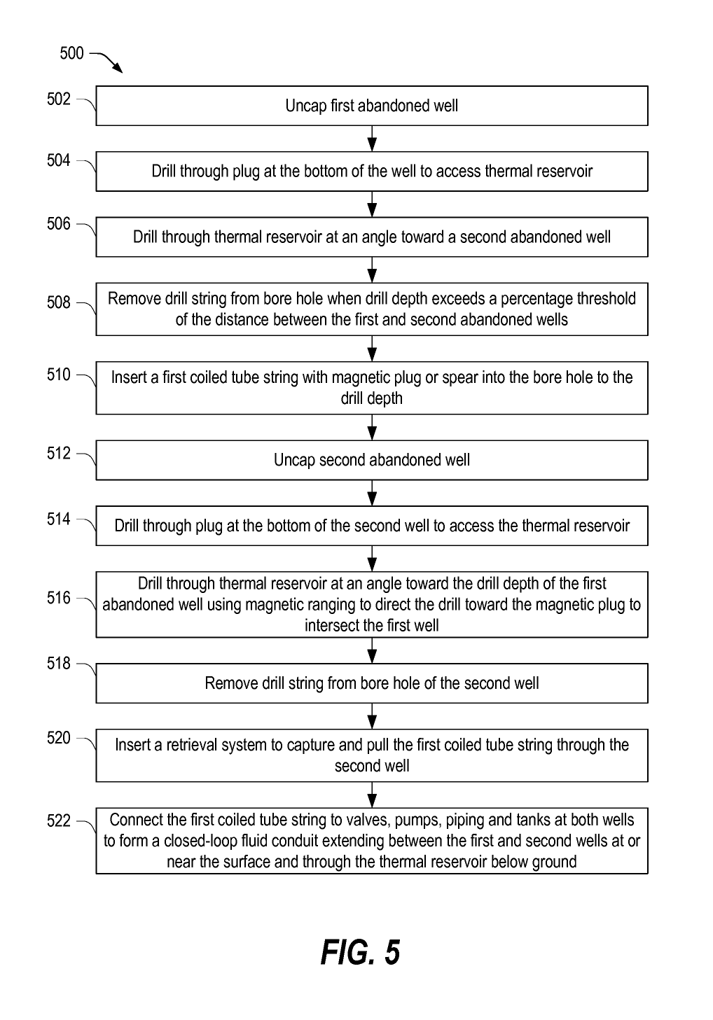

The above-examples, with respect to FIGS. 1-4, have depicted aspects of a geothermal system configured to produce electricity based on heat carried by fluid circulated through at least one cased well, (such as an abandoned oil or gas well) through a subterranean thermal reservoir 114, and through a second cased well to the surface. One process for forming the closed-loop pipe system is described below with respect to FIG. 5.

FIG. 5 is a flow diagram of an embodiment of a method 500 of assembling the closed-loop fluid conduit of FIG. 1. Often, oil wells or gas wells may be spaced geometrically across a surface of a geophysical formation that that contains a reservoir of oil or natural gas. When the reservoir is depleted, the casing at the bottom of the well bore is plugged with a cement plug and the well is capped and abandoned. In such wells, the subterranean reservoir may be pumped full of salt water or other formation fluid prior to plugging and capping the well. Such wells may be identified and re-permitted for use in producing electricity.

At 502, a first abandoned well is uncapped. Advancing to 504, drilling equipment is used to drill through the cement plug at the bottom of the well to access thermal reservoir 114. Moving to 506, the drilling equipment is used to drill through thermal reservoir 114 at an angle toward a second abandoned well. In a particular embodiment, the drilling equipment drills substantially horizontally or laterally toward the second abandoned well, which may be several hundred or thousands of feet from the first abandoned well.

Continuing to 508, a drills string is removed from the bore hole when the drill depth exceeds a percentage threshold of the distance between the first and second abandoned wells. In an embodiment, the percentage threshold is approximately fifty percent of the distance, and drilling is stopped and drill string removed when the lateral bore hole extends over fifty percent of the distance between the wells. Proceeding to 510, a coiled tube with a magnetic plug or spear point is inserted into the bore hole to the drill depth. In an alternative example, a pipe, a coiled tube, or other type of fluid conduit may be inserted into the bore hole to the drill depth.

Moving to 512, a second abandoned well is uncapped. In an example, the second abandoned well is adjacent to the first abandoned well within the field. Advancing to 514, drilling equipment drills through the cement plug at the bottom of the second well to access the thermal reservoir. Continuing to 516, the drilling equipment drills substantially horizontally or laterally through the thermal reservoir toward the drill depth of the first abandoned well using magnetic ranging to direct the drilling equipment toward the magnetic plug to intersect the first well.

Once the first well is intersected, the drill string is removed from the bore hole of the second abandoned well at 518. Moving to 520, a retrieval system is inserted into the second abandoned well to the drill depth to capture and pull the coiled tube (or other type of fluid conduit) through the second well. Proceeding to 522, the coiled tube (or other type of fluid conduit) is connected to valves, pumps, pipes, and tanks at both wells to form a closed-loop fluid conduit extending between the first and second wells at or near the surface and through the thermal reservoir below ground to create a closed loop. The method 500 may be repeated several times with multi-lateral holes until the maximum number of fluid conduits that will fit into the vertical casing of both wells is accomplished.

In general, multi-lateral holes from one well to another are only possible if the casings at the bottoms of the wells have diameters large enough to accommodate more than one set of coiled tubing and a drill bit. In the multi-lateral hole, after the first lateral conduit is connected, another hole is started off at an angle relative to the first lateral conduit. In an embodiment, the angle is approximately ninety degrees relative to the first lateral conduit, and the second lateral conduit then gradually curves toward the other well. Again, after a threshold percentage of the distance is exceeded, the second well is drilled to intersect the first lateral conduit, and a second loop is established.

The coiled tubing (or casing or other type of fluid conduit) may be left in place “as is” with formation fluids surrounding it, or may be cemented in place for better thermal coupling to the surrounding earth. In some instances, cementing of the coiled tubing (or casing or other type of fluid conduit) may help to prevent corrosion due to the formation fluids.

While the above-discussion has focused on single or multiple larger-diameter lateral conduits extending through the hot formation, it may be desirable to use an array of smaller diameter lateral conduits. In one instance, the multiple conduits could be inserted and pulled through individually as described above. Alternatively, an array of conduits could be inserted and pulled through the bore holes inside of a larger diameter casing, which could be left in situ to protect the smaller diameter conduits from the formation fluid or which could then be removed to expose each of the smaller diameter conduits directly to the formation fluid. Alternatively, the casing could be formed from a bio-degradable material that degrades over time to gradually expose the smaller diameter conduits to the formation fluid.

In some instances, it may be desirable to use different structures to heat the fluid within the conduit. If the conduit is cemented in concrete, heat is transferred through the concrete to the fluid using conduction. If the formation fluid surrounds the fluid conduit and heats the fluid, the heat is transferred using convection. In some instances, a steel casing may provide better heating than a coiled tube, and vice versa. Depending on the surrounding formation fluids and the temperature of the subterranean thermal reservoir 114, different lateral holes may have different heat transfer parameters, making it desirable to use different heat transfer techniques for the different lateral holes.

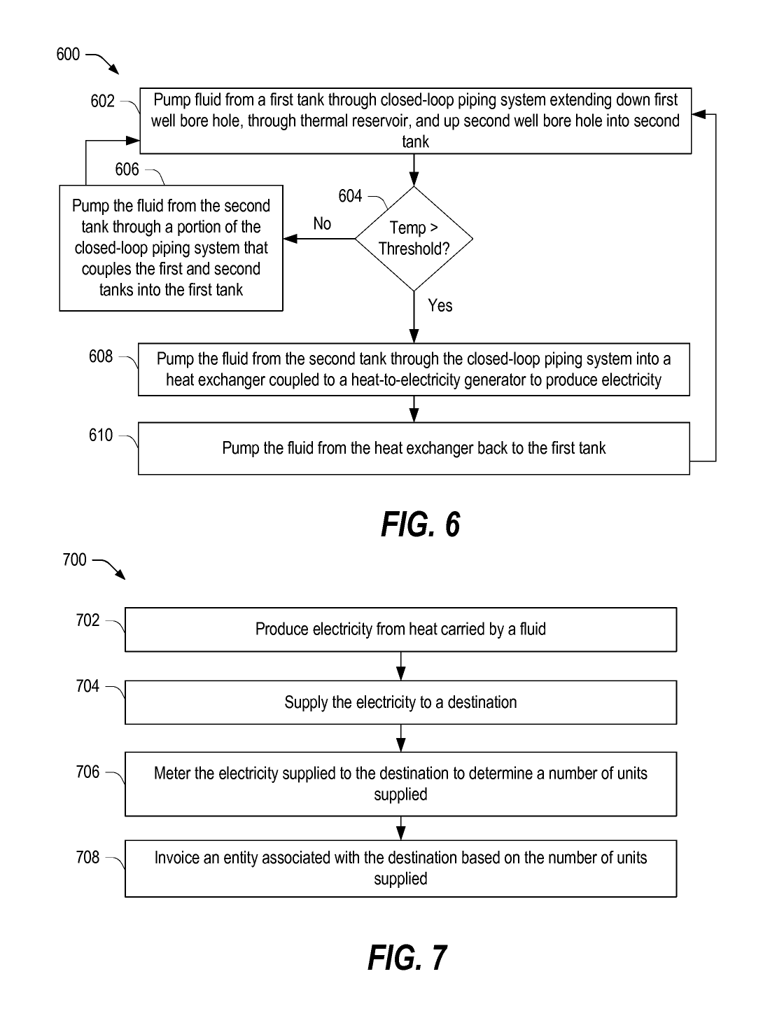

Once the closed-loop fluid conduit is established and the system is completed, the tanks and the fluid conduit are filled with a fluid for circulation through the closed-loop fluid conduit for heating of the fluid. The system circulates the fluid through subterranean thermal reservoir 114 one or more times to heat the fluid suitably for generating electricity using generator system 142. An example of a process for heating the fluid by such circulation is described below with respect to FIG. 6.

FIG. 6 is a flow diagram of an embodiment of a method 600 of controlling fluid flow through the closed-loop fluid conduit to heat a fluid and to produce electricity using the systems of FIGS. 1 and 2. At 602, control system 144 controls one or more pumps to pump fluid from first tank 136 through closed-loop pipe system extending down first well bore 118, through subterranean thermal reservoir 114, and up second well bore 122 into second tank 138. Circulation of the fluid through the closed-loop pipe system raises the temperature of the fluid from a first temperature (T₁) to a higher temperature (T₃).

Advancing to 604, the control system compares the higher temperature of the fluid to a threshold. If, at 604, the second temperature exceeds the threshold, the method advances to 608, and the control system 144 controls a plurality of valves and the one or more pumps to pump the fluid from the second tank through the closed-loop pipe system into a heat exchanger coupled to a heat-to-electricity generator to produce electricity. Proceeding to 610, the control system 144 controls one or more pumps to push the fluid from the heat exchanger back to the first tank and the method returns to 602.

Returning to 604, if the second temperature does not exceed the threshold, the method advances to 606 and the control system 144 controls the one or more pumps and a plurality of valves to pump the fluid from second tank 138 through a portion (fifth portion 132) of the closed-loop piping system that couples first tank 136 and second tank 138 and into first tank. Control system 144 continues to re-circulate the fluid through subterranean thermal reservoir 114 until the temperature within second tank 138 exceeds the threshold at 604. Once the second temperature of the fluid exceeds the threshold, the method proceeds to 608 and the system generates electricity. In particular, control system 144 controls pump 140 and valves 202 to drive fluid through electricity generator system 142 to produce electricity from thermal energy.

It should be appreciated that the temperature threshold may be determined by the temperature at which a low-temperature thermal generator system 142 begins to produce electricity. For example, an ORC system may be configured to generate electricity at temperatures that are below the boiling point of water. In another example, the temperature threshold can be configured by a user. In a particular example, electricity generator system 142 may be more efficient or may produce more electricity in response to higher fluid temperatures, and the user may configure the temperature threshold to be higher than the boiling point of water.

FIG. 7 is a flow diagram of an embodiment of a method 700 of metering the supply of electricity from the systems of FIGS. 1 and 2. At 702, a thermal generator produces electricity from heat carried by a fluid. One example of such a thermal generator is a low-temperature ORC system. Advancing to 704, a control system supplies the electricity to a destination, such as an electrical substation. Continuing to 706, the control system meters the electricity supplied to the destination to determine a number of units supplied. Moving to 708, a company associated with the thermal generator system invoices an entity associated with the destination based on the number of units supplied. The entity may be an electrical company that purchases electricity from one or more suppliers. Alternatively, the entity may be a municipality or other supplier or consumer of electricity.

Many abandoned wells having suitable down-hole temperatures exist in the Frio formation, the Wilcox formation, and other formations in Texas and in other states along the gulf coast. Such abandoned wells range in depth from 6,000 to 15,000 feet. Since the closed-loop circulation techniques and systems described above with respect to FIGS. 1-7 produce no oil or gas, energy production for such systems is not encumbered with royalties or severance taxes. Further, since water is not pumped out of the formations or re-injected, the system is environmentally neutral (benign). The only water used is in the cooling towers 232, 324, and 236 and any “make-up water” used for the fluid pumped into the down-hole loop. Further, no carbon dioxide is produced and no methane is brought to the surface. The system 100 produces base-load, extremely reliable, electricity with a very high availability factor. Once developed, the system 100 should operate for over 40 years with routine maintenance to the generators, pumps, valves, and piping system.

In an example, it may be desirable to select abandoned wells near existing electrical transmission lines. Preferably, such abandoned wells will have large-diameter casings at the bottom that terminate in hot formations and with appropriate well spacing, permitting the lateral drilling technique described above to produce the closed-loop conduit and that is suitably close to existing transmission lines. However, electrical lines could be run from the system to a substation or to existing transmission lines.

While the above-methods in FIGS. 5-7 describe re-purposing of abandoned wells, the above methods may also be applied to any cased well, including new wells. In such instances, the method may begin with lateral or horizontal drilling from the bottom of one cased well toward the other cased well, withdrawing the drill string, inserting a fluid conduit with a magnetic tip, and using magnetic range finding in conjunction with lateral drilling from the other cased well to intersect the previously drilled lateral hole. The drill string can be removed from the second cased well, and the coiled tube can be pulled through the lateral holes and up through the second cased well.

In conjunction with the systems and methods described above with respect to FIGS. 1-7, a closed-loop geothermal energy system is described that can be used to generate electricity from re-purposed, abandoned oil or gas wells or any type of cased wells. A lateral hole is established that connects a first cased well to a second cased well through a subterranean thermal reservoir, and a closed-loop fluid conduit is established that connects a first abandoned well and a second abandoned well through the lateral hole. The system controls a plurality of pumps and valves to circulate a fluid through the closed-loop fluid conduit and into a thermal generator (i.e., a heat-to-electricity converter) and back through the loop. Thus, the system generates electricity by circulating fluid through hot formation fluids within subterranean thermal reservoirs at the bottom of cased wells, and converting the heat carried by the fluid into electricity. The electricity can be sold to municipalities, to energy supply companies, to corporations, and/or to other energy supplies or energy consumers. The system provides an efficient, environmentally friendly, renewable energy system to produces energy from hot formations without depleting the formation fluids, thereby providing a sustainable energy generation system.

Although the present invention has been described with reference to preferred embodiments, workers skilled in the art will recognize that changes may be made in form and detail without departing from the scope of the invention.

What is claimed is:

1. A system comprising:
at least one pipe system defining a closed-loop fluid conduit configured to circulate a fluid into a cased well and through at least a portion of a subterranean thermal reservoir to heat the fluid; and
a thermal power system coupled to the at least one pipe system and configured to generate electricity from heat carried by the fluid.

2. The system of claim 1, wherein the cased well comprises at least one of a cased oil well and a cased gas well.

3. The system of claim 1, wherein the at least one pipe system comprises:
a first pipe portion extending through a first bore associated with the cased well to the subterranean thermal reservoir;
a second pipe portion extending through a second bore associated with a second cased well to the subterranean thermal reservoir; and
a third pipe portion extending through the subterranean thermal reservoir between the cased well and the second cased well, the third pipe portion including a first end coupled to the first pipe portion and a second end coupled to the second pipe portion.

4. The system of claim 3, further comprising:
a first tank adapted to store the fluid;
a first pump configured to pump the fluid from the first tank though the first pipe portion, the third pipe portion, and the second pipe portion into a second tank;
the second tank adapted to store the fluid after circulation through the subterranean thermal reservoir; and
a second pump configured to circulate the fluid through the thermal power system and back to the first tank.

5. The system of claim 1, wherein the thermal power system comprises an Organic Rankine Cycle system including at least one generator configured to convert heat into electricity.

6. The system of claim 1, further comprising:
a plurality of valves within the at least one pipe system; and
a control system coupled to the plurality of valves and configured to control flow of the fluid through the at least one pipe system.

7. The system of claim 1, wherein the subterranean thermal reservoir comprises a temperature that is at least 180 degrees higher than an ambient temperature.

8. The system of claim 1, wherein the fluid comprises a fluid composition having a boiling point temperature that is at or greater than 212 degrees Fahrenheit.

9. The system of claim 1, further comprising a control system coupled to the thermal power system and configured to meter the electricity generated by the thermal power system.

10. A method comprising:
circulating a fluid through a closed-loop pipe system having a portion that extends into a cased well and through a subterranean thermal reservoir to heat the fluid;
circulating the fluid through a second portion of the closed-loop pipe system that extends through a thermal-electric generator to convert heat carried by the fluid into electricity; and
supplying the electricity to a destination.

11. The method of claim 10, further comprising metering the electricity supplied to the destination.

12. The method of claim 10, wherein circulating the fluid through the closed-loop pipe system comprises:
storing the fluid in a first tank coupled to the closed-loop pipe system;
pumping the fluid from the first tank through the portion of the closed-loop pipe system that extends into the cased well and through the subterranean thermal reservoir and into a second tank;
measuring a temperature of the fluid in the second tank; and
selectively pumping the fluid from the second tank through one of the second portion of the closed-loop pipe system that extends through the thermal-electric generator and a third portion of the closed-loop pipe system that couples the second tank to the first tank in response to measuring the temperature.

13. The method of claim 12, wherein selectively pumping the fluid comprises:
comparing the temperature to a threshold temperature; and
controlling one or more valves to bypass the second portion of the closed-loop pipe system to direct the fluid through the third portion into the first tank when the temperature is below the threshold temperature for recirculation through the subterranean thermal reservoir.

14. The method of claim 12, wherein selectively pumping the fluid comprises:
comparing the temperature to a threshold temperature; and
controlling one or more valves to circulate the fluid through the second portion of the closed-loop pipe system when the temperature of the fluid exceeds the threshold temperature.

15. The method of claim 10, wherein the fluid comprises a fluid composition having a boiling point at or greater than 212 degrees Fahrenheit.

16. A system comprising:
a pipe system configured to provide a closed-loop fluid conduit for carrying a fluid from a surface through a first well bore associated with a cased well and through at least a portion of a subterranean thermal reservoir and back to the surface through a second well bore associated with a second cased well;
an electrical generator coupled to the pipe system and configured to generate electricity from heat carried by the fluid; and
a control system coupled to the electrical generator to control delivery of the electricity to a destination.

17. The system of claim 16, further comprising:
at least one pump coupled to the pipe system and configured to pump the fluid through the closed-loop fluid conduit; and
wherein the control system is configured to control the at least one pump to control circulation of the fluid through the pipe system.

18. The system of claim 16, wherein the pipe system comprises:
a fluid flow path through the electrical generator;
a bypass fluid flow path that bypasses the electrical generator to circulate the fluid back into the first well bore; and
a plurality of valves within the closed-loop fluid conduit and coupled to the control system; and
wherein the control system is configured to control the plurality of valves to selectively direct flow of the fluid through one of the fluid flow path and the bypass fluid flow path.

19. The system of claim 18, further comprising at least one temperature sensor coupled to the closed-loop fluid conduit near the second cased well and configured to measure a temperature of the fluid; and
wherein the control system selectively controls the plurality of valves to direct the flow of the fluid through the bypass fluid flow path when the temperature is below a temperature threshold.

20. The system of claim 16, wherein the fluid comprises a fluid composition having a boiling point at or greater than approximately 212 degrees Fahrenheit.

21. The system of claim 16, wherein the electrical generator comprises an Organic Rankine Cycle (ORC) generator.

22. A method of forming a geothermal electricity generation system, the method comprising:
drilling a first substantially lateral hole from a bottom of a first cased well toward a second cased well through a subterranean thermal reservoir to a pre-determined percentage of a distance between the first cased well and the second cased well;
extending piping having a magnetic tip through the first cased well and to the pre-determined percentage of the distance within the first substantially lateral hole;
drilling a second substantially lateral hole from a bottom of the second cased well toward the magnetic tip of the piping through a subterranean thermal reservoir until the second substantially lateral hole intersects the first substantially lateral hole;
pulling the piping through the second substantially lateral hole and through the second cased well; and
connecting the piping to a pipe system, the pipe system for coupling the first cased well and the second cased well to form a closed-loop fluid conduit including the piping.

23. The method of claim 22, further comprising:
coupling an electrical generation system including a heat exchanger to the pipe system adjacent to one of the first cased well and the second cased well; and
configuring a plurality of pumps to drive fluid through the pipe system, through the piping, through the heat exchanger, and back to the piping to produce electricity from heat carried by the fluid in the closed-loop fluid conduit.

24. The method of claim 22, wherein the first cased well and the second cased well comprise at least one of a new deep well, a pre-existing deep well, a shut-in well, and an abandoned deep well.

25. The method of claim 22, wherein the first cased well comprises a shut-in or abandoned oil or gas well, and wherein before drilling the first substantially lateral hole, the method comprises:
uncapping the first cased well; and
drilling through a rigid plug at the bottom of the first cased well to access the subterranean thermal reservoir.

26. The method of claim 22, wherein drilling the second substantially lateral hole from a bottom of the second cased well toward the magnetic tip of the piping comprises:
using magnetic ranging to detect the magnetic tip of the piping to determine an intersection location associated with the first substantially lateral hole; and
adjusting a drilling direction toward the intersection location based on detection of the magnetic tip.
